(19) United States
(12) Patent Application Publication
(10) Pub. No.: US 2006/0172070 A1
(43) Pub. Date: Aug. 3, 2006

(54) Method of producing logos or color codes for weight plates and weight heads

(76) Inventor: Guofang Cao, Diamond Bar, CA (US)

Correspondence Address: LAW OFFICES OF J.F. LEE, 17800 CASTLETON STREET, SUITE 383, CITY OF INDUSTRY, CA, 91748, US

(21) Appl. No.: 10/906,022

(22) Filed: Jan. 31, 2005

(51) Int. Cl. B05D 5/00; B05D 1/36

(52) U.S. Cl. 427/258; 427/402

(57) ABSTRACT

Present invention provides a cost-effective method for imprinting private logos, customized labels, or any poundage numbers onto the surface of weight plates and weight heads. A clear layer of urethane or polyurethane coating is applied to the outside of weight plates/heads after silk-screen printing is done, or alternatively, using pre-printed stickers, achieving great flexibility and economy in meeting clients need without the need to engage in mass production.

### BACKGROUND OF INVENTION

The present invention relates generally to fitness equipment and weight lifting; especially to the method of producing private logos, poundage numbers or color codes or other desired labels for weight plates used on the “free weights” system where the weight plates can be added to or removed from the lifting bar at the choice of individual users.

There are also cost benefits even for fitness equipment where the weight is fixed at certain poundage by using “weight heads”, such as dumbbells.

For purpose of invention disclosure in this application, weight plates would also encompass weight heads, unless specifically stated otherwise.

For the protection of gym floor and other fitness equipment, and reducing noise level when working out, weight plates nowadays are coated with non-metallic material such as rubber, urethane, polyurethane, over the machined steel or cast iron core that make up the weight plates.

Most weight plates are black or in solid colors chosen by the merchants or the gyms who ordered the weight plates. Business logos can be added to the weight plates, as well as the nominal weight numbers. Currently, either a molding containing the desired logos/labels or weight number has to be produced for the coating, or engraving has to be performed to show the logos on the surface of weight plates.

If the weight plates are not produced on a mass scale, the molding costs or the engraving costs are oftentimes prohibitively high.

### SUMMARY OF INVENTION

Present invention provides a cost-effective method for fitness equipment merchants to put their private logos, poundage numbers and/or other desired labeling on the weight plates, at a lower cost, even though the production is not done on a mass scale.

### BRIEF DESCRIPTION OF DRAWINGS

The accompanying drawings, which are incorporated in and constitute a part of this specification, illustrate the preferred embodiments of the invention and together with the description, serve to explain the principles of the invention.

A brief description of the drawings is as follows:

FIG. 1 shows a cut-out view of a weight plate having a logo and a number imprinted to the surface of the weight plate, along with its clear urethane or polyurethane layer. Alternatively, FIG. 1 can also depict a weight plate having number stickers attached to the surface of the weight plate, along with its clear urethane or polyurethane layer.

FIG. 2 shows an image of completed product as disclosed in present invention.

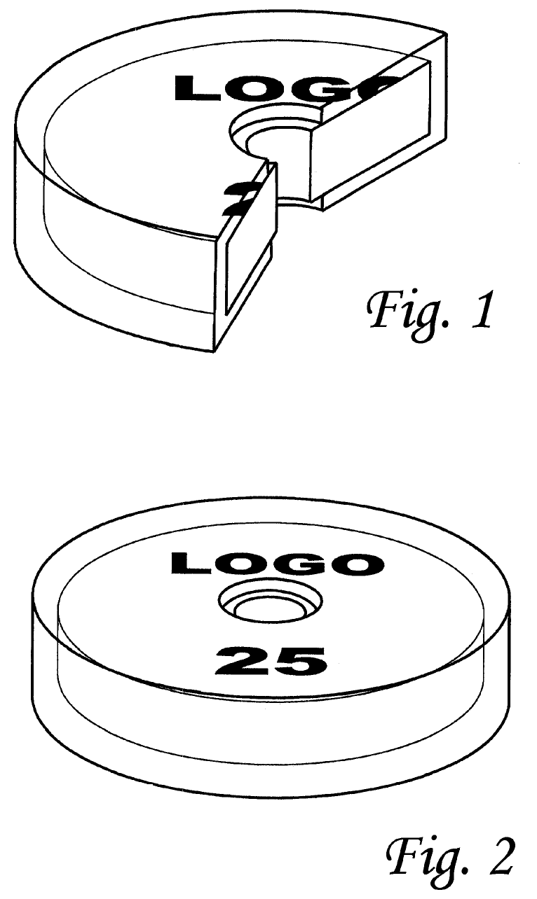

### DETAILED DESCRIPTION

Present invention utilizes a commonly known silk-screen printing technique, which needs no disclosure. Silk-screen printing, in and of itself, is not a patentable invention, except as it is otherwise used and claimed in this application.

To imprint logos or labels on to weight plates pursuant to the method of present invention, first make a silk-screen printing pattern for the logo/label.

Then, print that logo/label, or any other desired poundage numbers onto the surface of the weight plates.

Finally, a clear layer of urethane or polyurethane coating can be applied to the surface of the weight plates, so that the private logos, poundage numbers and any customized labels can be seen through the transparent layer of coating.

Alternatively, the private logos, labels and/or poundage numbers can be attached to the surface of the weight plates by using pre-printed stickers having the desired logos, labels and/or poundage numbers, then apply the aforementioned transparent layer of urethane or polyurethane coating.

In the case where gyms or merchants want to have a certain color appear on the weight plates, as symbolic representation or some form of association, the color can be printed on to the surface of the weight plate first, then go through the steps stated above to complete the imprinting and coating process, or putting on stickers and then coating process.

What is claimed is:

1. A method of producing logos or color codes on weight plates, comprising:
a. Step one, make a silk-screen printing pattern for the logos, color codes or any poundage numbers;
b. Step two, print said pattern of logo and/or color codes onto the surface of the weight plates; and,
c. Step three, coat the printed surface of the weight plates with clear urethane or polyurethane so that the logo and/or color codes can be seen through the layer of clear urethane or polyurethane.

2. A method of producing logos or color codes on weight plates, comprising:
a. Step one, prepare stickers containing desired logos, color codes or any poundage numbers;
b. Step two, attached said stickers in Step one onto the surface of the weight plates; and,
c. Step three, coat the surface of the weight plates with clear urethane or polyurethane so that the logo and/or color codes can be seen through the layer of clear urethane or polyurethane.
